(19) United States
(12) Patent Application Publication
(10) Pub. No.: US 2022/0126904 A1
(43) Pub. Date: Apr. 28, 2022

(54) CHILD STROLLER WITH AN ACCOMMODATING COMPONENT

(71) Applicant: Bambino Prezioso Switzerland AG, Steinhausen (CH)

(72) Inventor: Ling-Yi Lo, Taipei (TW)

(73) Assignee: Bambino Prezioso Switzerland AG, Steinhausen (CH)

(21) Appl. No.: 17/506,707

(22) Filed: Oct. 21, 2021

(30) Foreign Application Priority Data
Oct. 23, 2020 (CN) 202011152086.1

(51) Int. Cl. B62B 9/26; B62B 7/04

(52) U.S. Cl. CPC B62B 9/26; B62B 7/04

(57) ABSTRACT

A child stroller with simple structure and large accommodating space is provided and includes a stroller frame, a seat frame, a soft component and an accommodating component. The seat frame is disposed on the stroller frame. The soft component at least partially covers the stroller frame and the seat frame. The accommodating component is connected to a side of the soft component. An accommodating pocket is formed between the accommodating component and the soft component and for accommodating an object. An opening is formed on a side of the accommodating pocket and for allowing the object to enter into or exit from the accommodating pocket.

### BACKGROUND OF THE INVENTION

### 1. Field of the Invention

The present application related to a child stroller, and more specifically, to a child stroller with an accommodating component.

### 2. Description of the Prior Art

A child stroller is a vehicle specifically designed fora child and has become indispensable when a parent goes shopping with his/her child. However, sometimes, the parent needs to control the child stroller by one hand and hold things by the other hand, which causes not only a serious burden on the parent's body but also a potential hazard to the child's safety. The conventional child stroller usually includes a basket for accommodating things, so as to allow the parent to control the child stroller and carry the things easily. However, due to limited accommodating space of the basket, when there are too many things to be carried, the parent still needs to control the child stroller by one hand and hold the rest things by the other hand. Furthermore, the parent cannot place things into the basket in an organized manner. Therefore, the conventional child stroller needs to be improved.

### SUMMARY OF THE INVENTION

It is an objective of the present application to provide a child stroller with an accommodating component for solving the aforementioned problem.

In order to achieve the aforementioned objective, the present application discloses a child stroller including a stroller frame, a seat frame, a soft component and an accommodating component. The seat frame is disposed on the stroller frame. The soft component at least partially covers the stroller frame and the seat frame. The accommodating component is connected to aside of the soft component. An accommodating pocket is formed between the accommodating component and the soft component for accommodating an object. An opening is formed on a side of the accommodating pocket.

According to an embodiment of the present application, the accommodating component is disposed beneath a seat portion of the seat frame.

According to an embodiment of the present application, the accommodating component includes a first side, a second side, a third side and a fourth side. The first side and the second side are opposite to each other. The third side and the fourth side are opposite to each other and adjacent to the first side and the second side. The first side and the second side are connected to the soft component, and the third side and the fourth side are separated from the soft component to form the opening, so as to allow a parent to place an object into the accommodating pocket or take the object out of the accommodating pocket via the opening.

According to an embodiment of the present application, the accommodating component is disposed behind a seatback portion of the seat frame or disposed beside a bottom basket of the stroller frame.

According to an embodiment of the present application, the opening is formed on an upper portion of the accommodating pocket.

According to an embodiment of the present application, the child stroller further includes a fastening assembly disposed on the accommodating component and adjusting a size of the accommodating pocket, so as to allow the parent to adjust the size of the accommodating pocket by operating the fastening assembly according to a size of an object to be stored or a number of objects to be stored.

According to an embodiment of the present application, the fastening assembly is a zipper assembly. The zipper assembly includes a first locking portion and a second locking portion, and the first locking portion and the second locking portion are arranged in a V shape.

According to an embodiment of the present application, the fastening assembly includes a first buckle component and a plurality of second buckle components. The plurality of second buckle components are spaced from each other, and the first buckle component is for engaging with one of the plurality of second buckle components for adjusting the size of the accommodating pocket.

According to an embodiment of the present application, the soft component and the accommodating component are fixedly connected to each other by stitching.

According to an embodiment of the present application, the accommodating component is made of cloth.

According to an embodiment of the present application, the stroller frame is configured to be foldable.

According to an embodiment of the present application, the child stroller further includes a hand strap located adjacent to the opening formed on the side of the accommodating pocket.

According to an embodiment of the present application, the child stroller further includes a rubber sleeve disposed on the hand strap.

According to an embodiment of the present application, a seat portion and a seatback portion of the seat frame are pivotally connected each other, and the hand strap is located adjacent to a pivotal connection of the seat portion and the seatback portion.

In contrast to the prior art, in the present application, when the parent pushes the child stroller outside, the parent can place objects into the accommodating pocket via the opening for freeing his/her hands, so that the parent can control the child stroller and carry objects easily. Furthermore, when there are a plurality of accommodating pockets, the parent can place objects in an organized manner, e.g., place different objects into different accommodating pockets, so that the parent can find a desired one quickly. Therefore, the present invention has simple structure, large accommodating space and convenience of use.

These and other objectives of the present application will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a child stroller according to an embodiment of the present application.

FIG. 2 is a partial diagram of the child stroller according to the embodiment of the present application.

FIG. 3 is a partial diagram of the accommodating component according to the embodiment of the present application.

FIG. 4 is a partial diagram of an accommodating component according to another embodiment of the present application.

### DETAILED DESCRIPTION

In order to illustrate technical specifications and structural features as well as achieved purposes and effects of the present application, relevant embodiments and figures are described as follows.

In the following detailed description of the preferred embodiments, reference is made to the accompanying drawings which form a part hereof, and in which is shown by way of illustration specific embodiments in which the present application may be practiced. In this regard, directional terminology, such as “top”, “bottom”, “front”, “back”, etc., is used with reference to the orientation of the Figure(s) being described. The components of the present application can be positioned in a number of different orientations. As such, the directional terminology is used for purposes of illustration and is in no way limiting. Accordingly, the drawings and descriptions will be regarded as illustrative in nature and not as restrictive. Also, the term “connect” is intended to mean either an indirect or direct mechanical connection. Thus, if a first device is coupled to a second device, that connection may be through a direct mechanical connection, or through an indirect mechanical connection via other devices and connections.

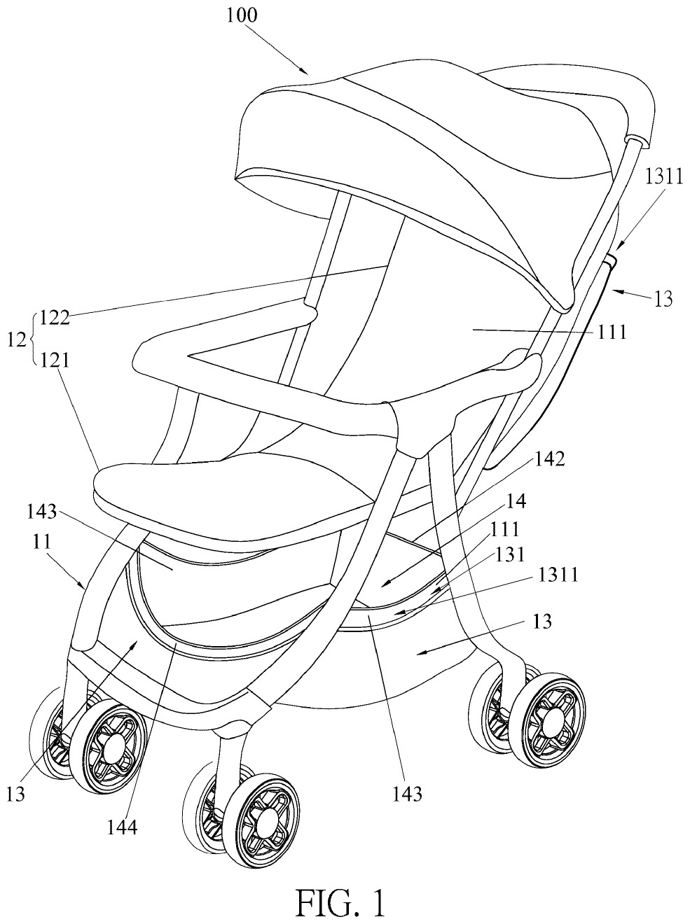

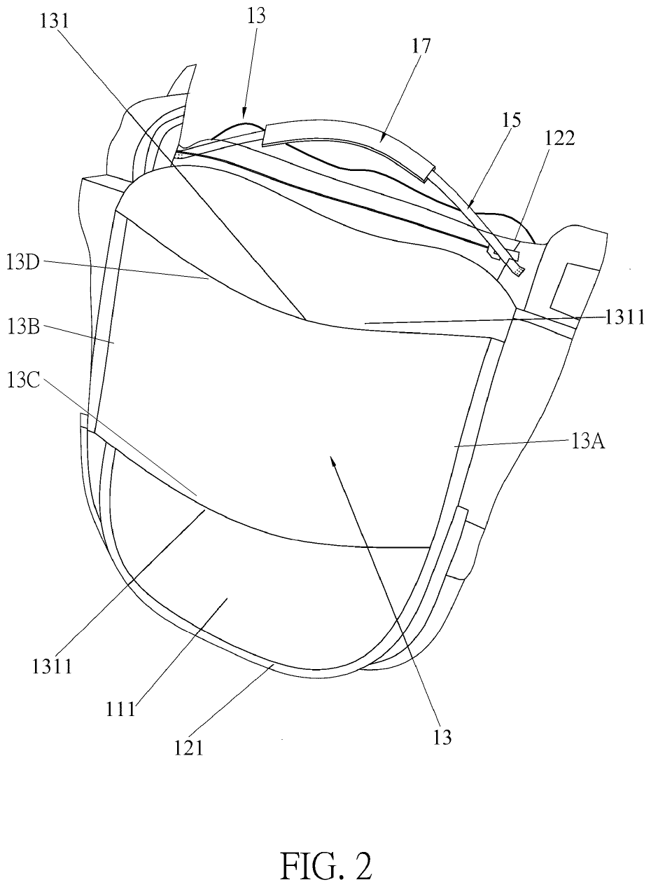

Please refer to FIG. 1 and FIG. 2. FIG. 1 is a schematic diagram of a child stroller 100 according to an embodiment of the present application. FIG. 2 is a partial diagram of the child stroller 100 according to the embodiment of the present application. As shown in FIG. 1 and FIG. 2, the child stroller 100 includes a stroller frame 11, a seat frame 12 and a soft component 111. The seat frame 12 is disposed on the stroller frame 11. The soft component 111 at least partially covers the stroller frame 11 and the seat frame 12. The soft component 111 can be a soft seat cloth cover. The soft component 111 can provide adequate support for a child or other things. Specifically, the seat frame 12 includes a seat portion 121 and a seatback portion 122. Furthermore, the child stroller 100 further includes six accommodating components 13. Each of the accommodating components 13 is connected to a corresponding side of the soft component 111. An accommodating pocket 131 is formed between each of the accommodating components 13 and the soft component 111. At least one opening 1311 is formed on at least one side of each of the accommodating pockets 131 and for allowing an object to enter into or exit from the corresponding accommodating pocket 131. When a parent pushes the child stroller 100 outside, the parent can place objects into the accommodating pocket 131 via the opening 1311 for freeing his/her hands, so that the parent can control the child stroller 100 and carry the objects easily. Furthermore, when there are a plurality of accommodating pockets 131, the parent can place objects in an organized manner, e.g., place different objects into the different accommodating pockets 131, so that the parent can find a desired one quickly. Therefore, the present application has simple structure, large accommodating space and convenience of use.

Specifically, the soft component 111 and the accommodating component 13 can be fixedly connected to each other by stitching. However, the present application is not limited thereto. For example, in another embodiment, the soft component and the accommodating component can be detachably connected to each other by a zipper. Preferably, each of the soft component 111 and the accommodating component 13 can be made of cloth.

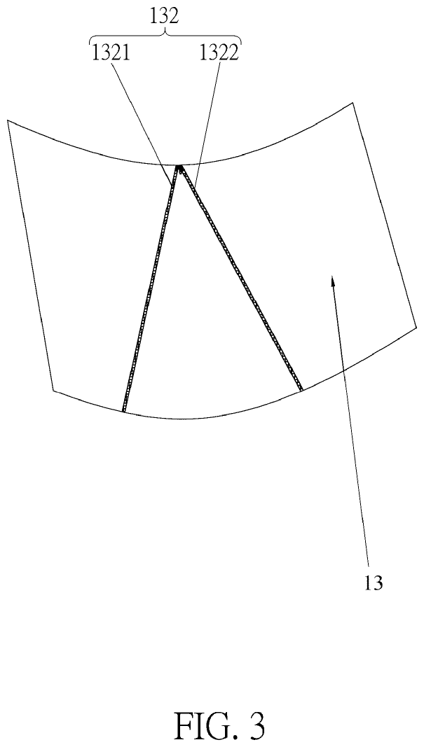

More specifically, please refer to FIG. 3. FIG. 3 is a partial diagram of the accommodating component 13 according to the embodiment of the present application. As shown in FIG. 3, the child stroller 100 further includes at least one fastening assembly 132 disposed on the corresponding accommodating component 13 and for adjusting a size of the corresponding accommodating pocket 131. The fastening assembly 132 can be a zipper assembly including a first locking portion 1321 and a second locking portion 1322. The first locking portion 1321 and the second locking portion 1322 can be arranged in a V shape. In such a way, a portion of the accommodating component 13 located between the first locking portion 1321 and the second locking portion 1322 can be folded for reducing the size of the accommodating pocket 131 when the first locking portion 1321 and the second locking portion 1322 are engaged with each other, and the portion of the accommodating component 13 located between the first locking portion 1321 and the second locking portion 1322 can be unfolded for expanding the size of the accommodating pocket 131 when the first locking portion 1321 and the second locking portion 1322 are disengaged from each other. Therefore, in the present application, the parent can adjust the size of the accommodating pocket 131 by operating the fastening assembly 132 easily according to a size of an object to be stored or a number of objects to be stored.

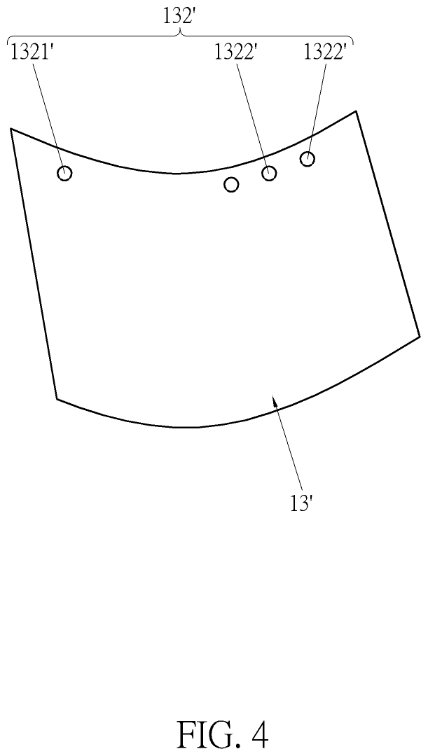

However, the present application is not limited to this embodiment. For example, please refer to FIG. 4. FIG. 4 is a partial diagram of an accommodating component 13′ according to another embodiment of the present application. As shown in FIG. 4, in order to adjust a size of an accommodating pocket, a fastening assembly 132′ of this embodiment includes a first buckle component 1321′ and a plurality of second buckle components 1322′. The first buckle component 1321′ and the second buckle components 1322′ can be snap buttons. The plurality of second buckle components 1322′ are spaced from each other, and the first buckle component 1321′ is for engaging with or disengaging from one of the plurality of second buckle components 1322′ for folding or unfolding the accommodating component 13′ to adjust the size of the accommodating pocket.

As shown in FIG. 1 and FIG. 2, specifically, in this embodiment, one of the accommodating components 13 is disposed beneath the seat portion 121 of the seat frame 12. More specifically, the accommodating component 13 beneath the seat portion 121 of the seat frame 12 includes a first side 13A, a second side 13B, a third side 13C and a fourth side 13D. The first side 13A and the second side 13B are opposite to each other. The third side 13C and the fourth side 13D are opposite to each other and adjacent to the first side 13A and the second side 13B. The first side 13A and the second side 13B are connected to the soft component 111. The third side 13C and the fourth side 13D are separated from the soft component 111 to form the two openings 1311 respectively. In such a way, the parent can place an object into the accommodating pocket 131 or take the object out of the accommodating pocket 131 via the opening 1311 adjacent to the third side 13C or the opening 1311 adjacent to the fourth side 13D.

Besides, in another embodiment, the child stroller can further include two sealing components for sealing the two openings adjacent to the third side and the fourth side respectively, so as to prevent an object from falling out of the accommodating pocket. The sealing component can be a zipper. However, the present application is not limited thereto.

As shown in FIG. 1 and FIG. 2, specifically, in this embodiment, another one of the accommodating components 13 is disposed behind the seatback portion 122 of the seat frame 12. More specifically, the opening 1311 can be formed on an upper portion of the accommodating pocket 131 behind the seatback portion 122 of the seat frame 12. When the parent pushes the child stroller 100 outside, the parent can place an object into the accommodating pocket 131 behind the seatback portion 122 via the opening 1311 for freeing his/her hands, so that the parent can control the child stroller 100 and carry the object easily.

Furthermore, in this embodiment, the other four of the accommodating components 13 are disposed beside four walls of a bottom basket 14 of the child stroller 11 respectively. Specifically, the bottom basket 14 includes a rear wall 142, two lateral walls 143 and a front wall 144 opposite to the rear wall 142. The two lateral walls 143 are connected between the rear wall 142 and the front wall 144 and opposite to each other. The four accommodating components 13 are disposed beside outer portions of the rear wall 142, the two lateral walls 143 and the front wall 144 respectively. In other words, the four accommodating pockets 131 are formed on an outer portion of the bottom basket 14. Furthermore, the opening 1311 is formed on an upper portion of each of the four accommodating pockets 131 for allowing the parent to place objects in an organized manner, e.g., place different objects into the different accommodating pockets 131, so that the parent can find a desired one quickly.

However, the number and the configuration of the accommodating component are not limited to the aforementioned embodiment. It depends on practical demands. For example, in another embodiment, the child stroller can include eight accommodating component respectively disposed on inner portions and outer portions of the rear wall, the two lateral walls and the front wall of the bottom backset. Alternatively, the child stroller can include one accommodating component disposed beneath the seat portion of the seat frame, or behind the seatback portion of the seat frame, or beside an inner portion or an outer portion of one wall of the bottom basket.

As shown in FIG. 1 and FIG. 2, the stroller frame 11 can be configured to be foldable. Structure of the stroller frame 11 can be similar to structure of a conventional foldable stroller frame. Detailed description is omitted herein for simplicity. The child stroller 100 further includes a hand strap 15 located adjacent to one of the openings 1131 formed on a side of the accommodating pocket 131 beneath the seat portion 121. Specifically, the seat portion 121 and the seatback portion 122 are pivotally connected to each other. Preferably, the hand strap 15 is located adjacent to a pivotal connection of the seat portion 121 and the seatback portion 122. When the child stroller 100 is folded, the accommodating pocket 131 located beneath the seat portion 121 is not folded. Therefore, the parent not only can carry the child stroller 100 by holding the hand strap 15 but also can place an object into the accommodating pocket 131 beneath the seat portion 121. Preferably, the child stroller 100 further includes a rubber sleeve 18 disposed on the hand strap 15 for allowing the parent to carry the child stroller 100 stably.

In contrast to the prior art, in the present application, when the parent pushes the child stroller outside, the parent can place objects into the accommodating pocket via the opening for freeing his/her hands, so that the parent can control the child stroller and carry objects easily. Furthermore, when there are a plurality of accommodating pockets, the parent can place objects in an organized manner, e.g., place different objects into different accommodating pockets, so that the parent can find a desired one quickly. Therefore, the present application has simple structure, large accommodating space and convenience of use.

Those skilled in the art will readily observe that numerous modifications and alterations of the device and method may be made while retaining the teachings of the present application. Accordingly, the above disclosure should be construed as limited only by the metes and bounds of the appended claims.

What is claimed is:

1. A child stroller comprising:
a stroller frame;
a seat frame disposed on the stroller frame;
a soft component at least partially covering the stroller frame and the seat frame; and
an accommodating component connected to a side of the soft component, an accommodating pocket being formed between the accommodating component and the soft component for accommodating an object, an opening being formed on a side of the accommodating pocket.

2. The child stroller of claim 1, wherein the accommodating component is disposed beneath a seat portion of the seat frame.

3. The child stroller of claim 2, wherein the accommodating component comprises a first side, a second side, a third side and a fourth side, the first side and the second side are opposite to each other, the third side and the fourth side are opposite to each other and adjacent to the first side and the second side, the first side and the second side are connected to the soft component, and the third side and the fourth side are separated from the soft component to form the opening.

4. The child stroller of claim 1, wherein the accommodating component is disposed behind a seatback portion of the seat frame or disposed beside a bottom basket of the stroller frame.

5. The child stroller of claim 4, wherein the opening is formed on an upper portion of the accommodating pocket.

6. The child stroller of claim 1, further comprising a fastening assembly disposed on the accommodating component and adjusting a size of the accommodating pocket.

7. The child stroller of claim 6, wherein the fastening assembly is a zipper assembly, the zipper assembly comprises a first locking portion and a second locking portion, and the first locking portion and the second locking portion are arranged in a V shape.

8. The child stroller of claim 6, wherein the fastening assembly comprises a first buckle component and a plurality of second buckle components, the plurality of second buckle components are spaced from each other, and the first buckle component is for engaging with one of the plurality of second buckle components for adjusting the size of the accommodating pocket.

9. The child stroller of claim 1, wherein the soft component and the accommodating component are fixedly connected to each other by stitching.

10. The child stroller of claim 1, wherein the accommodating component is made of cloth.
